(19) United States
(12) Patent Application Publication
(10) Pub. No.: US 2024/0340265 A1
(43) Pub. Date: Oct. 10, 2024

(54) VALIDATION OF CONNECTION REQUESTS FOR A FIREWALL

(71) Applicant: International Business Machines Corporation, Armonk, NY (US)

(72) Inventors: Scott Lawrence Strattner, Ulster, NY (US); Fernando Luiz Koch, Greenwich, CT (US)

(21) Appl. No.: 18/131,724

(22) Filed: Apr. 6, 2023

(51) Int. Cl. H04L 9/40; H04L 61/4511

(52) U.S. Cl. CPC H04L 63/0236; H04L 61/4511

(57) ABSTRACT

A computer-implemented method, according to one embodiment, includes causing a client DNS resolution request to be stored to a predetermined query caching database, and receiving a request from a firewall to determine a validity of a connection request received by the firewall from a client device. The connection request is for a resolved IP address associated with the client DNS resolution request. Contents of the predetermined query caching database are used to determine the validity of the connection request. The method further includes using the determined validity results to control whether the client device is allowed to connect to the resolved IP address. A computer program product, according to another embodiment, includes a computer readable storage medium having program instructions embodied therewith. The program instructions are readable and/or executable by a computer to cause the computer to perform the foregoing method.

### BACKGROUND

The present invention relates to network egress traffic, and more specifically, this invention relates to using contents of a predetermined query caching database to determine a validity of a connection request for a firewall.

In typical deployments, an enterprise is concerned with protecting internal resources of the enterprise. For example, connection requests of client devices of the enterprise are often monitored to ensure that the client devices do not connect to internet protocol (IP) addresses determined to be malicious and capable of causing losses and/or unauthorized access to devices of the enterprise. For example, an enterprise may implement security controls on predetermined internal domain name system (DNS) servers to look for known, potentially harmful destinations, e.g., such as sites hosting malware, etc. These security controls may additionally and/or alternatively not allow resolution for these sites. Furthermore, client devices and/or users that made such requests may be entered into a program that educates on the relative dangers of accessing such potentially harmful destinations.

### SUMMARY

A computer-implemented method, according to one embodiment, includes causing a client DNS resolution request to be stored to a predetermined query caching database, and receiving a request from a firewall to determine a validity of a connection request received by the firewall from a client device. The connection request is for a resolved IP address associated with the client DNS resolution request. Contents of the predetermined query caching database are used to determine the validity of the connection request. The method further includes using the determined validity results to control whether the client device is allowed to connect to the resolved IP address.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using contents of a predetermined query caching database to determine a validity of a connection request for a firewall.

In one general embodiment, a computer-implemented method includes causing a client DNS resolution request to be stored to a predetermined query caching database, and receiving a request from a firewall to determine a validity of a connection request received by the firewall from a client device. The connection request is for a resolved IP address associated with the client DNS resolution request. Contents of the predetermined query caching database are used to determine the validity of the connection request. The method further includes using the determined validity results to control whether the client device is allowed to connect to the resolved IP address.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as validity determination module of block 150 for using contents of a predetermined query caching database to determine a validity of a connection request for a firewall. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

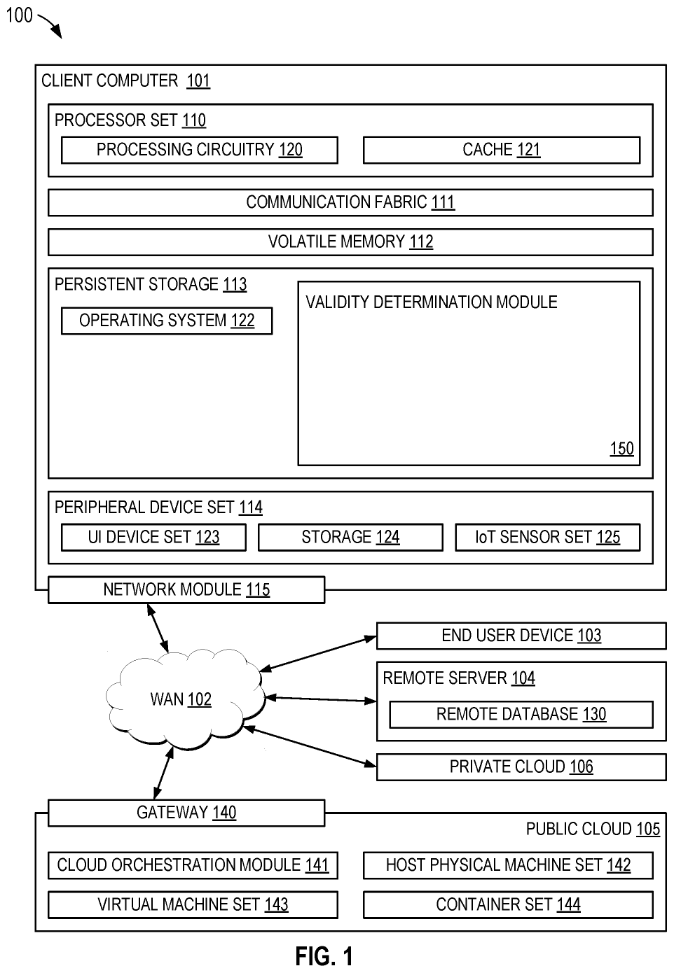

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, in typical deployments, an enterprise is concerned with protecting internal resources of the enterprise. For example, connection requests of client devices of the enterprise are often monitored to ensure that the client devices do not connect to internet protocol (IP) addresses determined to be malicious and capable of causing losses and/or unauthorized access to devices of the enterprise. For example, an enterprise may implement security controls on predetermined internal domain name system (DNS) servers to look for known, potentially harmful destinations, e.g., such as sites hosting malware, etc. These security controls may additionally and/or alternatively not allow resolution for these sites. Furthermore, client devices and/or users that made such requests may be entered into a program that educates on the relative dangers of accessing such potentially harmful destinations.

Implementation of the security controls mentioned above are relatively helpful for protecting internal resources of the enterprise, however, use of DNS over hypertext transfer protocols (HTTPs), i.e., “DoH” which is enabled by default in some browsers, enables internal clients to bypass enterprise DNS servers and thereby resolve domain names externally. This is problematic because an enterprise firewall cannot stop these bypasses without blocking all HTTPS traffic, which would be unacceptable in the enterprise deployment. Accordingly, there is a longstanding need for techniques that allow an enterprise to block connection attempts from client devices that are not using an approved internal DNS server to make resolution requests.

In sharp contrast to the deficiencies of the conventional implementations described above, the techniques of various embodiments and approaches described herein protect networks by dynamically authorizing, e.g., on-line, real-time, etc., network egress connection using DNS resolvers by creating a conceptual link between DNS requests and firewall authorizations. More specifically, these techniques use contents of a predetermined query caching database to determine a validity of a connection request for a firewall. DoH is not stopped, in some approaches, clients relying on it will not be able to leave the enterprise network. This ensures that the enterprise DNS servers are the only approved systems for providing name resolution, and that DNS-based security controls of the DNS servers are not being bypassed. Accordingly, the novel techniques described herein solve the problem of client systems inside an enterprise environment making connections to unknown external resources, by requiring all such connections to correspond to DNS queries to approved enterprise DNS forwarders and/or resolvers.

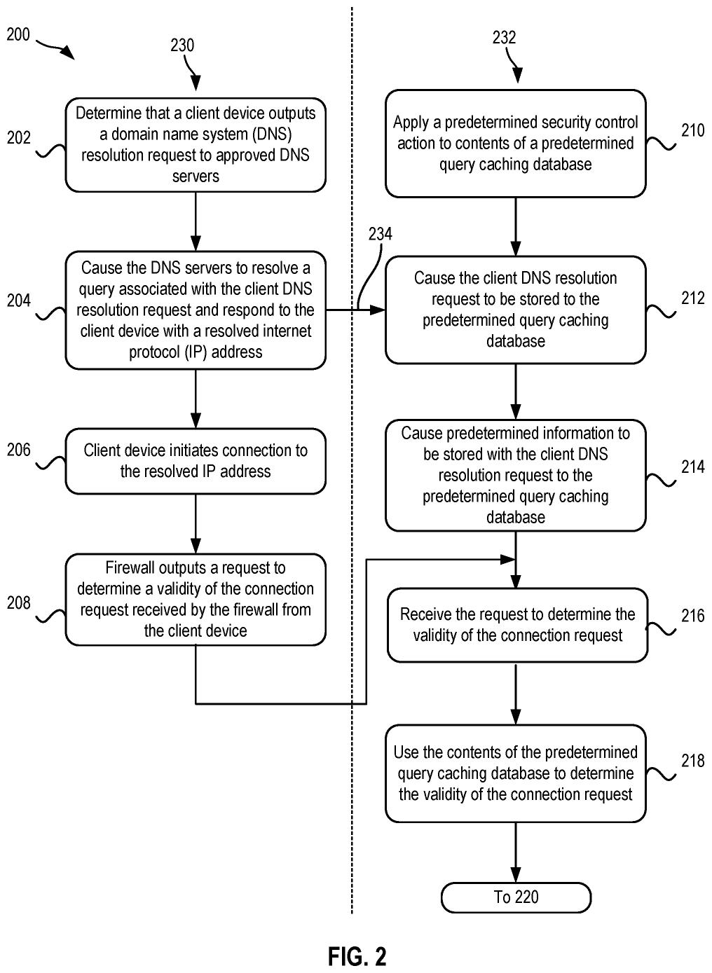

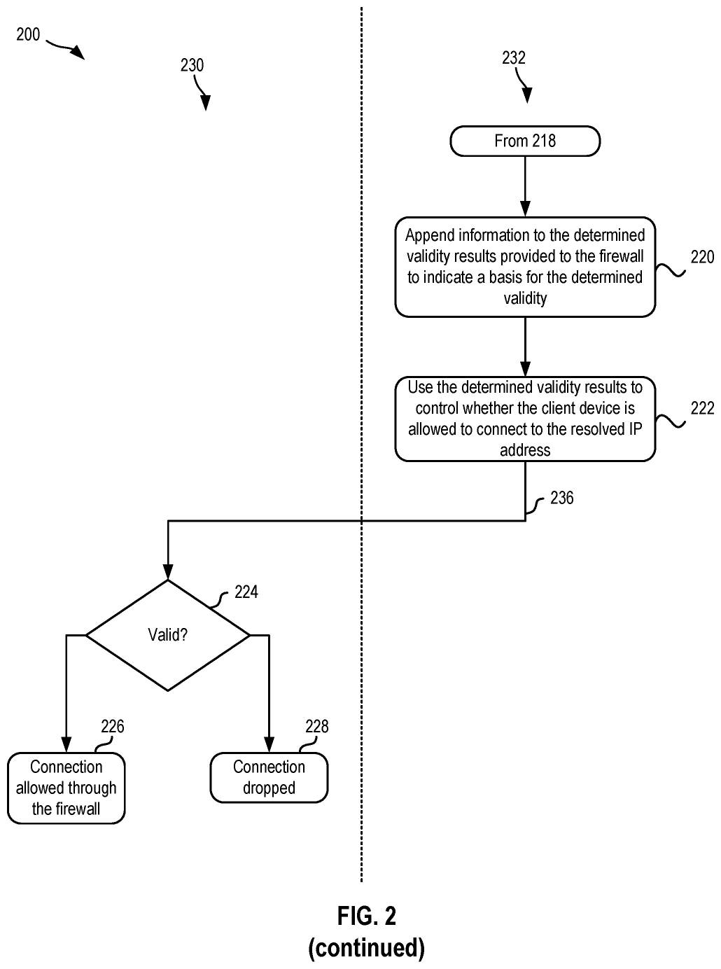

Now referring to FIG. 2, a flowchart of a method 200 is shown, according to one embodiment. The method 200 may be performed in accordance with the present invention in any of the environments depicted in FIGS. 1-3, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that the flowchart of FIG. 2 illustrates two logical paths, e.g., see first logical path 230 and second logical path 232. In some approaches, the first logical path 230 includes operations that are performed between a client device and/or a firewall. The client device may include a known type of client device, e.g., a computer, a controller, a cellular phone, etc., that is preferably configured to request connection to and/or connect to an IP address. The firewall may be of a type that would become apparent to one of ordinary skill in the art after reading the descriptions herein. In some approaches, the second logical path includes operations that are performed by a computer and/or controller, which may be of a type that would become apparent to one of ordinary skill in the art after reading the descriptions herein. In some approaches the computer includes and/or is in communication with a query caching database. The computer and/or controller and/or query caching database may, in some approaches, be in communication with the firewall and/or a device that is configured to deploy the firewall.

In some approaches, a client device may attempt to access web based resources via a known type of network egress traffic. For example, the client device may output a domain name system (DNS) resolution request in response to a domain name being entered into a uniform resource locator (URL) search bar displayed on the client device. In some approaches, the DNS resolution request is output to, e.g., routed by an enterprise network egress controller to at least one approved DNS server, e.g., predetermined authorized DNS server(s). Accordingly, in some approaches, it may be determined that the client device outputs the DNS resolution request to the approved DNS servers, e.g., see operation 202. Known techniques that would become apparent to one of ordinary skill in the art after reading the descriptions herein may be used for monitoring for and detecting such client device outputs.

In response to the determination that the client device outputs the DNS resolution request to the approved DNS servers, the DNS servers may initiate a predetermined process for resolving a query associated with the DNS resolution request. In other words, the DNS resolution request may request that the DNS servers perform a query, e.g., on predetermined tables, to determine a response that includes an IP address that is associated with the client DNS resolution request. For context, the IP address is “associated” with the client DNS resolution request in that the IP address is the address that the client device may connect to in order to access the domain name that was entered into the URL search bar. In some approaches, the DNS servers are caused, e.g., instructed by the computer of the second logical path 232, to resolve the query associated with the client DNS resolution request and respond to the client device with a resolved internet protocol (IP) address, e.g., see operation 204. In some other approaches, the DNS servers are not caused, but instead elect to resolve the query associated with the client DNS resolution request and respond to the client device with a resolved internet protocol (IP) address in response to receiving the client DNS resolution request from the client device.

Operation 212 includes causing the client DNS resolution request to be stored to a predetermined query caching database. In some approaches, the client DNS resolution request is stored to the predetermined query caching database in response to the client DNS resolution request being received, e.g., by the computer, from the DNS servers. For example, operation 234 includes receiving the client DNS resolution request and response from the authorized DNS servers. In some approaches, the client DNS resolution request and/or response is received subsequent to and/or in response to performing a direct application programming interface (API) call, writing to a distributed ledger as in a blockchain-based implementation, or other techniques for inserting data into a predetermined database that would become apparent to one of ordinary skill in the art after reading the descriptions herein. In one or more of such approaches, the client DNS resolution request may be received at the predetermined query caching database from at least one of the authorized DNS servers.

In some approaches, the client DNS resolution request is stored with information associated with the request to the predetermined query caching database, e.g., see operation 214. For example, in one preferred approach, the client DNS resolution request is stored with information that includes the response. The response may, in some approaches, include the IP address of the resolved query, e.g., response “192.168.1.1”. This response may include the resolved IP address, e.g., the IP address determined by the DNS server(s) and returned to the requesting client device. This response may additionally and/or alternatively be returned to the client computer before or after the client DNS resolution request and/or the information is stored to the predetermined query caching database. In some other approaches, the information may additionally and/or alternatively include an IP address of the client device, a timestamp indicating a time at which the client DNS resolution request was received (a time of the query), a timestamp indicating a time at which the resolved IP address was provided to the client device, a timestamp indicating a time at which the information is stored to the predetermined query caching database, a time that the query was performed, the query such as “www.example.com”, etc.

In some approaches, a response may be returned to the DNS server, e.g., such as to acknowledge receipt and/or acknowledge that the information has been stored to the predetermined query caching database. In some other approaches, method 200 does not include responding to the DNS servers, but instead merely includes collating such requests and client device information to thereafter be used for determining a validity of a connection request for the firewall, e.g., as will be described in greater detail elsewhere below.

With reference again to the first logical path 230, subsequent to the client device receiving the response with the resolved IP address, the client device may initiate connection to the resolved IP address, e.g., see operation 206. In some preferred approaches, the firewall is configured to control access of the client device to any IP address, e.g., control whether connection is allowed through the firewall or dropped. Accordingly, in some approaches, the firewall may detect the initiated connection and/or receive a notification (such as a request received by the firewall from the client device) to allow the connection to an IP address through the firewall, e.g., hereafter referred to as a “connection request”. In some approaches, the connection request is for the resolved IP address associated with the client DNS resolution request.

The firewall may output a request for determining a validity of the connection request, e.g., see operation 208. The request to determine the validity of the connection request may be received and accepted from the firewall, e.g., see operation 216. In some approaches, the request received from the firewall (and/or received from another network edge security device), may ask whether an initial packet that the firewall has received from the client device, e.g., where the packet includes a source and destination IP address, is valid. In other words, the firewall may request verification that the client device made a DNS request that resulted in the destination, in the timeframe considered appropriate. It should be noted that, in some approaches, method 200 may not rely on any specific API format, e.g., representational state transfer (REST) API, simple object access protocol (SOAP) API, etc., so long as the request data indicates the information necessary to provide a valid response. As will now be described below, the request is preferably thereafter validated to ensure only approved network devices can query the database.

Operation 218 includes optionally using contents of the predetermined query caching database to determine the validity of the connection request. In some approaches, method 200 includes applying a predetermined security control action to contents of a predetermined query caching database, e.g., see operation 210. For context, the predetermined security control action may be applied to contents of a predetermined query caching database in order to cause enforcement of the predetermined security control action with respect to network egress in a network and/or enterprise that includes the client device. In some approaches, the predetermined security control action is performed on contents of the predetermined query caching database to determine the validity of the connection request. Various illustrative techniques for cause enforcement of the predetermined security control action are described below.

In some approaches, in order to enforce the predetermined security control action, method 200 may include performing optional actions against the data received, such as passing the query and response to other security tools to validate a relative ‘cleanliness’ of the site and/or IP, e.g., cleanliness with respect to one or more predetermined conditions. For example, in some approaches, method 200 includes maintaining a blocklist of predetermined domains that client devices are not allowed access to. Contents of the internet blocklist may be extracted from one or more predetermined domains and/or trusted resources. In response to a determination that the resolved IP address is on the blocklist, enforcing the predetermined security control action may include generating a reply for outputting to the firewall and/or returning and storing on the predetermined query caching database that flags the resolved IP address as untrustworthy.

The predetermined security control action may, in some approaches, additionally and/or alternatively include responding to the request from the firewall by modification of the client query validation. For example, in response to a determination that the client device makes a query for “www.example.com”, which returns “192.168.1.1” as the resolved IP address, and in response to a determination that “www.example.com” exists on the maintained blocklist, method 200 may include ensuring that any request by an egress network device returns a negative reply, e.g., an instruction to not allow a connection to the resolved IP address. In one approach, this may be ensured by returning the negative reply to any firewall that requests verification of a connection request for the resolved IP address “192.168.1.1”. In another approach, this may be ensured by generating a response to the firewall that instructs the firewall to block all connection requests that request the resolved IP address “192.168.1.1”. Note that, in some approaches, the predetermined security control action may be performed by a device, e.g., computer, that performs one or more of the operations of the second logical path 232. In some other approaches, the predetermined security control action may be performed by passing the received DNS resolution request for determining the validity of the connection request and the resolved IP address to a predetermined trained malware check model that is configured to perform one or more of the operations described herein for verifying the connection request.

The predetermined security control action may additionally and/or alternatively include considering whether a period of time that occurs between the client DNS resolution request being received and the request from the firewall being received exceeds a predetermined threshold of time, e.g., one hour, one day, three months, etc. For context, typically where a client device is requesting a DNS query the request is made because the client device is attempting to make the request at that time. By considering whether the predetermined amount of time is exceeded, it may be ensured that the DNS query was not made more than the predetermined amount of time before a currently performed connection attempt to the resolved IP address to the firewall. This is preferably ensured because where the predetermined amount of time is exceeded, the IP address may have since been added to the blocklist of predetermined domains that client devices are not allowed access to. Accordingly, the connection request is, in some approaches, determined to be not valid in response to a determination that the period of time exceeds the predetermined threshold of time. In contrast, the connection request may, in some approaches, be determined to be valid in response to a determination that the period of time exceeds the predetermined threshold of time. Note that timestamp information stored in the predetermined query caching database may be referenced to determine whether the predetermined threshold of time has been exceeded. In some other approaches, the predetermined security control action may additionally and/or alternatively include a DNS/IP-based IPS/malware prevention action of a type that would become appreciated by one of ordinary skill in the art after reading the descriptions herein.

Operation 218 includes using the determined validity results to control whether the client device is allowed to connect to the resolved IP address. In some preferred approaches, using the determined validity results to control whether the client device is allowed to connect to the resolved IP address includes providing an answer, e.g., hereafter referred to as “determined validity results”, that indicates the validity of the connection request to a network egress device, e.g., a device such as a server that is capable of hosting and enforcing the firewall. In some approaches, the determined validity results are caused to be output from the predetermined query caching database to the firewall.

The determined validity results may, in some approaches, include a simple Boolean result, e.g., true or false, yes or no, etc. In some other approaches, the determined validity results may additionally and/or alternatively provide additional details such as why the connection request is valid, e.g., can be trusted and allowed, or invalid, cannot be trusted and should not be allowed. For example, these additional details may be information that is appended to the determined validity provided to the firewall to indicate a basis for the determined validity, e.g., see operation 220. In some approaches, in response to a determination that the connection request is the result of the client device resolving the IP address, but the IP address is flagged as inappropriate during the validity check, the reply preferably is negative in that information that the destination IP address is not allowed may be appended to the response returned to the firewall, e.g., see operation 236. The firewall (or other network edge security device) may then be caused, e.g., instructed, to act on this additional information, perhaps by globally blocking all access to/from this IP address, e.g., as will be described elsewhere herein in operations 224-228.

Information that is appended to the determined validity results may, in some approaches, additionally and/or alternatively include a validity scoring determined for the connection request during the validity determination, identification of block lists queried to determine the validity of the connection request, an identification of which of the block lists included the resolved IP address, etc.

Operation 222 includes using the determined validity results to control whether the client device is allowed to connect to the resolved IP address. In some approaches, using the determined validity results to control whether the client device is allowed to connect to the resolved IP address includes causing the determined validity results to be provided to the firewall, e.g., see operation 236. In some preferred approaches, the determined validity results include an instruction for enforcing the determined validity. For example, the client device is preferably allowed to connect to the resolved IP address in response to the determined validity results indicating that the connection request is valid, e.g., see operation 226. In contrast, the client device is preferably not allowed to connect to the resolved IP address in response to the determined validity results indicating that the connection request is not valid, e.g., see operation 228. Note that, in some approaches, the determined validity results and/or an instruction included therein and/or information appended thereto may be used by the firewall and/or a device that enforces the firewall to determine whether or not to allow the connection, e.g., see decision 224.

Various benefits and performance improvements of an enterprise are enabled as a result of implementing the techniques described herein. For example, it should be noted that the techniques described herein effectively create a conceptual link between DNS requests and firewall authorizations. Consequently, in response to a determination that a client device attempts to connect to another IP address directly, e.g., “1.1.1.2” the attempted connection is refused because the connection attempt to the IP address has not been resolved through DNS before. It should also be noted that these techniques establish a method to dynamically collate enterprise DNS queries and firewall authorization attempts, as well as a techniques for registering DNS requests linking to client credential and resolved addresses to thereby form a DNS resolve context. These techniques also enable management of the DNS resolve context database, and it should be noted that this logic does not rely on the implementation specifics of the database, whether instantiated as a standard SQL-based system or a hyper-ledger, etc. Furthermore, the techniques described herein verify whether connection authorization requests are valid in the current context, e.g., incoming client, destination IP, etc. This logic makes use of the DNS resolve context to verify the validity of the requests. These benefits ultimately improve performance of infrastructure of the enterprise because client devices are prevented from connecting to IP addresses that have the potential for compromising performance of the architecture, e.g., such as IP addresses that are associated with malware and therefore added to the maintained blocklist. These techniques have heretofore not been considered in conventional applications. Accordingly, the inventive discoveries disclosed herein with regards to using contents of a predetermined query caching database to determine a validity of a connection request for a firewall proceed contrary to conventional wisdom.

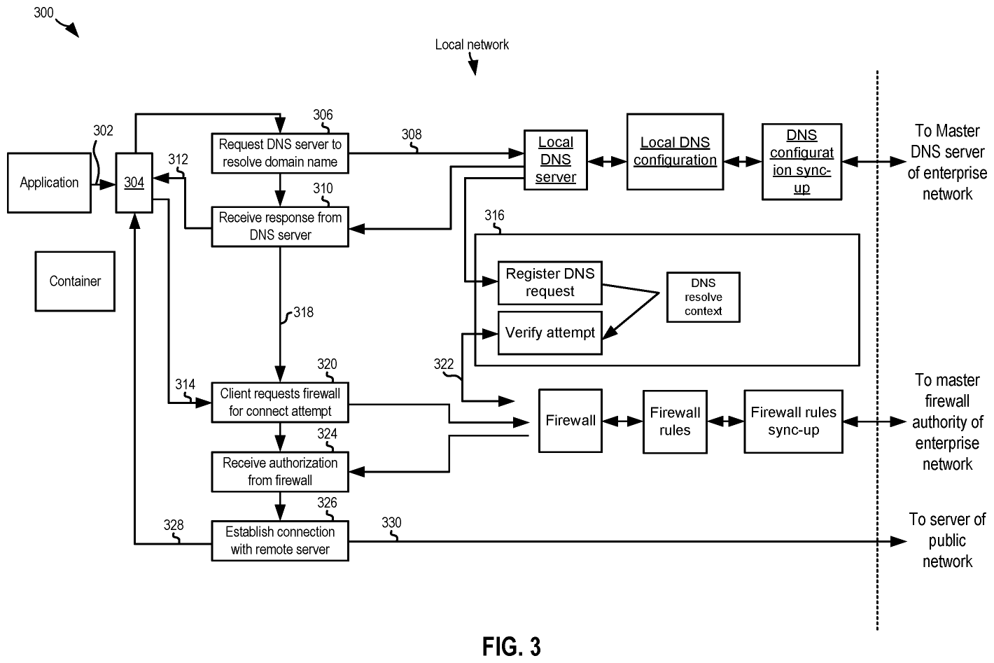

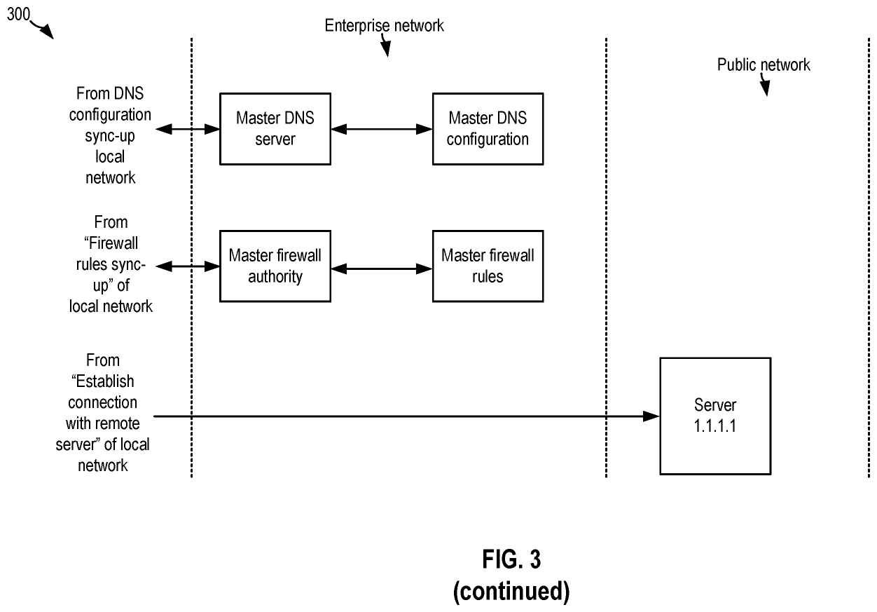

Now referring to FIG. 3, a flowchart of a method 300 is shown, according to one embodiment. The method 300 may be performed in accordance with the present invention in any of the environments depicted in FIGS. 1-3, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 may, in some approaches, be considered a relatively detailed view of techniques for using contents of a predetermined query caching database to determine a validity of a connection request for a firewall. More specifically, method 300 includes operations for dynamically collating enterprise DNS queries and firewall authorization attempts to prevent client devices from connecting to untrustworthy IP addresses, and moreover to prevent client devices from using the bypassing DoH techniques described elsewhere above to connect to untrustworthy IP addresses. In order to accomplish this, access attempts are verified through a firewall by checking whether a destination IP address has ever been the answer of a valid DNS request by the source IP (client device), using data accumulated in a predetermined database. It may also be noted that method 300 illustrates several operations that are performed across an infrastructure that spans across a plurality of networks, e.g., see local network, enterprise network, and public network.

In the local network, an application of a client device may be used to issue a client DNS resolution request, and the client DNS resolution request may be detected, e.g., see operation 302. It may be assumed that the client DNS resolution request is an attempt to resolve the domain “example.com”. The request may be output by the client device to a connection thread 304 and received by at least one approved DNS server, e.g., see operation 306 and 308. In some approaches, an IP address of the client device, e.g., “10.0.0.1”, is received with the request and/or extracted from the request. The local DNS server reference a local DNS configuration and/or perform a DNS configuration sync-up with a master DNS server with access to a master DNS configuration of the enterprise network to determine a resolved IP address for the client DNS resolution request, e.g., resolved IP address “1.1.1.1”. The resolved IP address is received from the DNS server, e.g., see operation 310, and returned to the client device, e.g., see operation 312.

It may also be noted that the client DNS resolution request may be stored to a predetermined query caching database, e.g., see operation 316 and “register DNS request”. This may include storing DNS resolve context information, e.g., an indication of the client DNS resolution request, the client device IP address, the resolved IP address, the requested domain, timestamp information, etc. In other words, the enterprise DNS queries are registered and results on a DNS resolve context by recording information such as, e.g., source IP (client device) requesting DNS resolution, a fully qualified domain name (FQDN) that the client device asks the server to resolve, an answer to the resolution (resolved IP address, if found), a timestamp of the query, etc.

This enables a dynamic collation of enterprise DNS queries and firewall authorization attempts. Furthermore, operation 318 includes creating a conceptual link between the DNS requests and firewall authorizations. This conceptual link will be further described below in the verification steps.

The client device may attempt to connect the resolved IP address, e.g., see operation 314. For example, the client device may issue a connection request to a firewall for connecting to the resolved IP address, e.g., see operation 320. The firewall may output a request that is received in method 300 to determine a validity of the connection request received by the firewall from a client device, where the connection request packet is for a resolved IP address associated with the client DNS resolution request. The contents of the predetermined query caching database may be used to determine the validity of the connection request, e.g., see “verify attempt”. One or more techniques described elsewhere herein for determining the validity of a connection request may be used to verify the connection request, e.g., see method 200. In some approaches, the validity of the connection request is determined by causing enforcement of a predetermined security control action on the client DNS resolution request.

Validity results may be determined and used to control whether the client device is allowed to connect to the resolved IP address. For example, the determined validity results may be returned to the firewall, e.g., see operation 322. The firewall may base whether the client device is allowed to connect to the resolved IP address through the firewall on the determined validity results. For example, authorization may be received from the firewall for establishing a connection with a remote server that hosts the resolved IP address, e.g., see operation 324-326. Thereafter the connection between the client device and the resolved IP address may be established through the firewall, e.g., see operations 328-330.

It should be noted that in response to a determination that the client device ever attempts to connect to another IP address directly, e.g., see container and “1.1.1.2”, the connection may be refused and a determination may be made that the connection request was not previously resolved through a DNS server before. This determination may, in some approaches, be made by the firewall and rules associated with the firewall, e.g., see firewall rules.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
causing a client DNS resolution request to be stored to a predetermined query caching database;
receiving a request from a firewall to determine a validity of a connection request received by the firewall from a client device, wherein the connection request is for a resolved IP address associated with the client DNS resolution request;
using contents of the predetermined query caching database to determine the validity of the connection request; and
using the determined validity results to control whether the client device is allowed to connect to the resolved IP address.

2. The computer-implemented method of claim 1, wherein using the determined validity results to control whether the client device is allowed to connect to the resolved IP address includes: causing the determined validity results to be provided to the firewall, wherein the client device is allowed to connect to the resolved IP address in response to the determined validity results indicating that the connection request is valid, wherein the client device is not allowed to connect to the resolved IP address in response to the determined validity results indicating that the connection request is not valid.

3. The computer-implemented method of claim 1, comprising: appending information to the determined validity results provided to the firewall to indicate a basis for the determined validity results.

4. The computer-implemented method of claim 3, wherein the appended information is selected from the group consisting of: a validity scoring determined for the connection request, identification of block lists queried to determine the validity of the connection request, and an identification of which of the block lists included the resolved IP address.

5. The computer-implemented method of claim 1, comprising: causing enforcement of a predetermined security control action on the client DNS resolution request.

6. The computer-implemented method of claim 5, wherein the predetermined security control action is selected from the group consisting of: maintaining a blocklist of predetermined domains that client devices are not allowed access to, passing the DNS resolution request and the resolved IP address to a predetermined trained malware check model, and considering whether a period of time that occurs between the client DNS resolution request being received and the request from the firewall being received exceeds a predetermined threshold of time.

7. The computer-implemented method of claim 6, wherein the connection request is determined to be not valid in response to a determination that the period of time exceeds the predetermined threshold of time.

8. The computer-implemented method of claim 1, wherein the client DNS resolution request is received from a predetermined authorized DNS server, wherein the client DNS resolution request is stored with information associated with the request.

9. The computer-implemented method of claim 8, wherein the information is selected from the group consisting of: an IP address of the client device, the resolved IP address, a timestamp indicating a time at which the client DNS resolution request was received, and a timestamp indicating a time at which the resolved IP address was provided to the client device.

10. A computer program product, the computer program product comprising a computer readable storage medium having program instructions embodied therewith, the program instructions readable and/or executable by a computer to cause the computer to:
cause a client DNS resolution request to be stored to a predetermined query caching database;
receive a request from a firewall to determine a validity of a connection request received by the firewall from a client device, wherein the connection request is for a resolved IP address associated with the client DNS resolution request;
use contents of the predetermined query caching database to determine the validity of the connection request; and
use the determined validity results to control whether the client device is allowed to connect to the resolved IP address.

11. The computer program product of claim 10, wherein using the determined validity results to control whether the client device is allowed to connect to the resolved IP address includes: causing the determined validity results to be provided to the firewall, wherein the client device is allowed to connect to the resolved IP address in response to the determined validity results indicating that the connection request is valid, wherein the client device is not allowed to connect to the resolved IP address in response to the determined validity results indicating that the connection request is not valid.

12. The computer program product of claim 10, the program instructions readable and/or executable by the computer to cause the computer to: append information to the determined validity results provided to the firewall to indicate a basis for the determined validity results.

13. The computer program product of claim 12, wherein the appended information is selected from the group consisting of: a validity scoring determined for the connection request, identification of block lists queried to determine the validity of the connection request, and an identification of which of the block lists included the resolved IP address.

14. The computer program product of claim 10, the program instructions readable and/or executable by the computer to cause the computer to: cause enforcement of a predetermined security control action on the client DNS resolution request.

15. The computer program product of claim 14, wherein the predetermined security control action is selected from the group consisting of: maintaining a blocklist of predetermined domains that client devices are not allowed access to, passing the DNS resolution request and the resolved IP address to a predetermined trained malware check model, and considering whether a period of time that occurs between the client DNS resolution request being received and the request from the firewall being received exceeds a predetermined threshold of time.

16. The computer program product of claim 15, wherein the connection request is determined to be not valid in response to a determination that the period of time exceeds the predetermined threshold of time.

17. The computer program product of claim 10, wherein the client DNS resolution request is received from a predetermined authorized DNS server, wherein the client DNS resolution request is stored with information associated with the request.

18. The computer program product of claim 17, wherein the information is selected from the group consisting of: an IP address of the client device, the resolved IP address, a timestamp indicating a time at which the client DNS resolution request was received, and a timestamp indicating a time at which the resolved IP address was provided to the client device.

19. A system, comprising:
a processor; and
logic integrated with the processor, executable by the processor, or integrated with and executable by the processor, the logic being configured to:
cause a client DNS resolution request to be stored to a predetermined query caching database;
receive a request from a firewall to determine a validity of a connection request received by the firewall from a client device, wherein the connection request is for a resolved IP address associated with the client DNS resolution request;
use contents of the predetermined query caching database to determine the validity of the connection request; and
use the determined validity results to control whether the client device is allowed to connect to the resolved IP address.

20. The system of claim 19, wherein using the determined validity results to control whether the client device is allowed to connect to the resolved IP address includes: causing the determined validity results to be provided to the firewall, wherein the client device is allowed to connect to the resolved IP address in response to the determined validity results indicating that the connection request is valid, wherein the client device is not allowed to connect to the resolved IP address in response to the determined validity results indicating that the connection request is not valid.
